(19) United States
(12) Patent Application Publication
(10) Pub. No.: US 2026/0115643 A1
(43) Pub. Date: Apr. 30, 2026

(54) ADSORPTION SYSTEM COMPRESSOR APPARATUS AND RELATED METHODS

(71) Applicant: Air Products and Chemicals, Inc., Allentown, PA (US)

(72) Inventor: Joseph Gerard Wehrman, Macungie, PA (US)

(73) Assignee: Air Products and Chemicals, Inc., Allentown, PA (US)

(21) Appl. No.: 18/925,207

(22) Filed: Oct. 24, 2024

(51) Int. Cl. B01D 53/047; F04D 17/10

(52) U.S. Cl. CPC B01D 53/0476; F04D 17/10; B01D 2253/102; B01D 2253/104; B01D 2253/106; B01D 2257/102; B01D 2257/502; B01D 2257/504; B01D 2257/80; B01D 2259/402

(57) ABSTRACT

A method for operation of an adsorption system can include passing a process fluid through a vessel to pressurize the vessel and adsorb one or more impurities from the process fluid via a bed of adsorbent material within a body of the vessel while the vessel is at a pre-selected purification pressure. The method can also include fluidly connecting the vessel to a dynamic compressor to adjust a pressure of the vessel to a pre-selected regeneration pressure that is lower than the pre-selected purification pressure to evacuate fluid from the vessel for removal of impurities desorbed from the adsorbent material.

### BACKGROUND OF THE INVENTION

The present innovation relates to methods and apparatuses for pressure swing adsorptions systems, apparatuses for vacuum swing adsorption systems, and related methods.

Pressure swing adsorption (PSA) processes can be operated between maximum and minimum cycle pressures. The cycling of pressure can be utilized to facilitate removal of impurities from a fluid and a subsequent regeneration of the adsorbent material via a release of the adsorbed impurities from the adsorbent material.

In some situations, a vacuum-pressure swing adsorption (VPSA) approach can utilize a cycling between maximum and minimum pressures as well. The cycling of pressure can be utilized to facilitate removal of impurities from a fluid and a subsequent regeneration of the adsorbent material via a release of the adsorbed impurities from the adsorbent material. For example, a maximum cycle pressure can be superatmospheric and the minimum cycle pressure can be subatmospheric. The cycling of pressure can be utilized to facilitate removal of impurities from a fluid and a subsequent regeneration of the adsorbent material via a release of the adsorbed impurities from the adsorbent material.

A vacuum swing adsorption (VSA) approach can also utilize a cycling between maximum and minimum pressures. The cycling of pressure can be utilized to facilitate removal of impurities from a fluid and a subsequent regeneration of the adsorbent material via a release of the adsorbed impurities from the adsorbent material. For VSA approaches, the maximum cycle pressure can be near atmospheric and the minimum cycle pressure can be subatmospheric.

### SUMMARY OF THE INVENTION

Each adsorbent bed in a PSA system, VSA system, or VPSA system can undergo operation in a number of steps of a cycle of operation. The cycle of operation can be repeated multiple times for cyclic operation. Each cycle proceeds through a sequence of steps beginning with a feed or adsorption step in which a pressurized feed gas is passed through a bed of adsorbent material in a vessel that selectively adsorbs one or more of the components in the feed gas. The adsorption system can output an output gas that has a lesser concentration of one or more impurities via the removal of the one or more impurities that can occur via the adsorbent material. The purified output gas can be withdrawn from the bed until the adsorption step is terminated at a pre-selected time.

After termination of the adsorption step, the pressure in the vessel having the adsorbent material is reduced in one or more pressure reducing steps in which gas is transferred at decreasing pressure to one or more other beds to provide pressurization gas to those beds. Final depressurization of the vessel typically is completed by evacuation using a vacuum blower, which facilitates a purging step of the cycle of operation. The depressurized vessel is often purged with product gas or transfer gas provided from other beds thereby removing additional adsorbed components and void space gas from the bed for regeneration of the adsorbent material of the bed.

Upon completion of the purge step, the bed is repressurized to an intermediate pressure by one or more pressurization steps in which gas is transferred from other beds, and the bed then is pressurized further to the feed pressure with feed and/or product gas.

Each cycle of operation can include all of these steps (e.g. adsorption, depressurization, purging, and re-pressurization). The cycling of pressure can occur numerous times in numerous cycles of operation.

Typically, a rotary lobe type blower or multiple rotary lobe blowers operating at fixed speeds is used to move gas through the vessel during the purging step. These machines are robust and generally do not experience any significant operational problems as the pressures and flows change. However, these machines have low power efficiency and conventional machines are about 60-65% efficient (e.g. about 35-40% of the energy supplied to these machines is often wasted). It was determined that it would be desirable to replace use of such a blower with a more efficient device or process capable of meeting rigorous requirements of rapid cyclic conditions that can be experienced in PSA, VSA, and VPSA type systems.

For instance, it was surprisingly discovered that such a blower can be replaced with a dynamic compressor (e.g. a centrifugal compressor) that can be operated at a constant rotational speed. The design parameters of the compressor can be selected to permit operation of the compressor in a choke region of operation for an initial choke period of operational time (e.g. an initial time period in which purging of the vessel having adsorbent material to be regenerated is to occur). Often, this choke region of operation can be between 5% to 60% (e.g. 5%-50%, 10%-50%, 10%-40%, 20%-60%, 10%-30%, etc.) of the overall purging time period. It was surprisingly found that such a cyclical operation of a dynamic compressor in a pre-defined choke region of operation for the compressor is acceptable and not problematic, which is contrary to conventional approaches to compressor operation and is often contrary to instructions provided by compressor suppliers.

Conventionally, it is believed that dynamic compressors normally avoid operation in a choke region of operation for various reasons. In a choke region of operation, a volumetric flow of fluid may not be sufficiently passed through the compressor due to choking of different parts. Such a choke region of operation is a region of operation of a dynamic compressor at which the pressure difference between what is within a vessel to be purged and the compressor output is insufficient to drive any additional flow of fluid through the compressor. Such an operational condition can result in turbulence occurring and was conventionally believed to place a higher stress on the compressor impeller(s). A secondary reason for the conventional avoidance of operating a compressor operation in its choke region of operation is due to the relatively low efficiency of compression. Because of this type of conventional thinking, dynamic compressors are not typically utilized in PSA, VSA, or VPSA type systems because of the cyclical nature of their operation and how often such cycles of operation occur.

To the extent compressors would be utilized in PSA, VSA, or VPSA type systems, a variable control of such compressors would have probably been thought to be needed to avoid operation in a choke region of operation for the compressor. However, it was surprisingly found that this is not the case. This can permit a less costly dynamic compressor that has a simpler motor (and a less expensive motor) to be utilized in embodiments of the apparatus and method (which can also be referred to as a process). Further, embodiments of the apparatus and method can utilize a much simpler and more flexible processing scheme due to the simplified operation of the dynamic compressor that can be provided. Embodiments of the apparatus and method may therefore provide a simpler, easier to manage process that is operates more efficiently as well as having a significantly lower capital cost. The simplification in operation can provide improved flexibility in operation as well.

For example, a centrifugal compressor can be utilized instead of a blower to provide an efficiency of about 85% for power utilization, which can provide a significant improvement over a conventional blower arrangement (e.g. a significantly more efficient use of power that can reduce power losses from 40%-35% to about 15%). Further, utilization of such a dynamic compressor can be provided at a lower capital cost for the improved operational efficiency that can be obtained. And, as noted above, embodiments can be provided as a constant rotational speed motor configuration that has a simpler motor and simpler control scheme for implementation, which can provide enhanced flexibility in controlling operations of the adsorption system and can be simpler to implement as well as permitting the dynamic compressor to be obtained at a much lower overall cost due to the simpler motor arrangement.

In a first aspect, a method for operation of an adsorption system can include passing a process fluid through a vessel to pressurize the vessel and adsorb one or more impurities from the process fluid via a bed of adsorbent material within a body of the vessel while the vessel is at a pre-selected purification pressure and fluidly connecting the vessel to a dynamic compressor to adjust a pressure of the vessel to a pre-selected regeneration pressure that is lower than the pre-selected purification pressure to evacuate fluid from the vessel for removal of impurities desorbed from the adsorbent material.

Embodiments of the method can be utilized in conjunction with an adsorption system configured as a PSA system, VSA system, or VPSA system. The dynamic compressor can be a centrifugal compressor that has a single impeller or multiple impellers in some embodiments. In some embodiments, the dynamic compressor can also include one or more intercoolers and/or an aftercooler.

In a second aspect, the method can also include operating the dynamic compressor in a choke area of operation while fluid from the vessel is evacuated for removal of the impurities. For example, the fluid can be evacuated from the vessel for removal of the impurities for a pre-selected regeneration period of time and the dynamic compressor can be operated in the choke area of operation for a period of time that is greater than 0% of the pre-selected regeneration period of time and is less than or equal to 60% of the pre-selected regeneration period of time. As another example, the fluid can be evacuated from the vessel for removal of the impurities for a pre-selected regeneration period of time and the dynamic compressor can be operated in the choke area of operation for a period of time that is greater than 5% of the pre-selected regeneration period of time and is less than or equal to 60% of the pre-selected regeneration period of time. As yet another example, the fluid can be evacuated from the vessel for removal of the impurities for a pre-selected regeneration period of time and the dynamic compressor can be operated in the choke area of operation for a period of time that is greater than 10% of the pre-selected regeneration period of time and is less than or equal to 60% of the pre-selected regeneration period of time. In yet other embodiments, the dynamic compressor can be operated in the choke area of operation for a period of time that is 10%-50%, 10%-40% or 20%-30% of the pre-selected regeneration period of time. In yet other embodiments, the dynamic compressor can be operated in the choke area of operation for another portion of the pre-selected regeneration period of time (e.g. between 15% and 35%, 20%-50%, etc.).

In some embodiments, the pre-selected regeneration period of time can be between 1 hour and 6 hours. In other embodiments, the pre-selected regeneration period of time can be another suitable time (e.g. between 2 hours and 8 hours, between 3 hours and 12 hours, etc.).

In a third aspect, the dynamic compressor is a centrifugal compressor having at least one impeller. For example, the dynamic compressor can be a centrifugal compressor having a single impeller, multiple impellers with at least one intercooler, or other type of centrifugal compressor arrangement. In some embodiments, the dynamic compressor can include a motor positioned and configured to drive rotation of the impeller(s) at a constant speed of rotation.

For some types of constant speed motor arrangements, an induction motor for the dynamic compressor can be provided in which the rotational speed of the impeller(s) driven by the motor may change slightly due to a load applied to the motor (e.g. the rotational speed may vary from a particular setting by up to 2% depending on the load applied to the motor). This type of slight variation in speed can be typical for some types of constant speed arrangements that provide for a constant speed of rotation of the impeller(s) as the speed of the dynamic compressor that is connected directly or through a gearbox to a drive device that operates at a set speed (e.g. a constant speed).

In a fourth aspect, the one or more impurities can include nitrogen, carbon dioxide, water, carbon monoxide, or combinations thereof. The impurities may also (or alternatively) include other constitutes of a process fluid.

In a fifth aspect, the adsorbent material can include activated carbon, silica, alumina, or combinations thereof. The adsorbent material may also, or alternatively, include other types of adsorbent material (e.g. CaX, zeolites, etc.).

In a sixth aspect, a method of the first aspect can include one or more features of the second aspect, third aspect, fourth aspect and/or fifth aspect. Embodiments can also include other features or elements. Examples of such features or elements can be appreciated from the exemplary embodiments of the method discussed herein.

In a seventh aspect, an adsorption system is provided. The adsorption system can include a first vessel adjustable between a purification operational state and a regeneration operational state. The first vessel can have a bed of adsorbent material within a body of the first vessel. The system can also include a second vessel adjustable between the purification operational state and the regeneration operational state so that the second vessel is in the purification operational state when the first vessel is in the regeneration operational state and the second vessel is in the regeneration operational state when the first vessel is in the purification operational state. The system can also include a dynamic compressor that can be positioned to be fluidly connectable to the first vessel when the first vessel is in the regeneration operational state and the dynamic compressor can also be positioned to be fluidly connectable to the second vessel when the second vessel is in the regeneration operational state. The first vessel can be fluidly connectable to an adsorption unit inlet conduit for receiving a process gas for purification of the process gas when the first vessel is in the purification operational state and the second vessel can be fluidly connectable to the adsorption unit inlet conduit for receiving the process gas for purification of the process gas when the second vessel is in the purification operational state. The dynamic compressor can be positioned and configured to decrease a pressure of the first vessel to a pre-selected regeneration pressure to remove impurities from the adsorbent material of the first vessel for a pre-selected regeneration period of time when the first vessel is in the regeneration operational state such that the dynamic compressor is configured to operate in a choke area of operation for a portion of the pre-selected regeneration period of time. The dynamic compressor can also be positioned and configured to decrease a pressure of the second vessel to the pre-selected regeneration pressure to remove impurities from the adsorbent material of the second vessel for the pre-selected regeneration period of time when the second vessel is in the regeneration operational state wherein the dynamic compressor can be configured to operate in a choke area of operation for a portion of the pre-selected regeneration period of time.

In a seventh aspect, the dynamic compressor can be a centrifugal compressor. The centrifugal compressor can have a single impeller or multiple impellers in some embodiments. In some embodiments, the centrifugal compressor can include one or more intercoolers and/or an aftercooler.

In an eighth aspect, the adsorption system can be configured as a PSA system, VSA system, or VPSA system.

In a ninth aspect, the portion of the pre-selected regeneration period of time at which the dynamic compressor is operatable in the choke area of operation is greater than 0% of the pre-selected regeneration period of time and is less than or equal to 60% of the pre-selected regeneration period of time. For instance, the dynamic compressor can be operatable in the choke area of operation for 5%-60% of the pre-selected regeneration period of time, 10%-60% of the pre-selected regeneration period of time, 10%-50% of the pre-selected regeneration period of time, 10%-40% of the pre-selected regeneration period of time, 20%-50% of the pre-selected regeneration period of time, 20%-60% of the pre-selected regeneration period of time, 15%-60% of the pre-selected regeneration period of time, or another portion of the pre-selected regeneration period of time.

In some embodiments, the pre-selected regeneration period of time can be between 1 hour and 6 hours or can be between 1 hour and 12 hours. In yet other embodiments, the pre-selected regeneration period of time can be another suitable time (e.g. between 2 hours and 4 hours, between 1 hour and 8 hours, etc.).

In a tenth aspect, the dynamic compressor includes at least one rotatable impeller and a motor positioned and configured to drive rotation of the at least one impeller at a constant speed of rotation. As noted above, in some types of constant speed motor arrangements, an induction motor for the dynamic compressor can be provided in which the rotational speed of the impeller(s) driven by the motor may change slightly due to a load applied to the motor (e.g. the rotational speed may vary from a particular setting by up to 2% depending on the load applied to the motor). This type of slight variation in speed can be typical for some types of constant speed arrangements that provide for a constant speed of rotation of the impeller(s) as the speed of the dynamic compressor that is connected directly or through a gearbox to a drive device that operates at a set speed (e.g. a constant speed).

In an eleventh aspect, the adsorbent material of the first vessel includes activated carbon, silica, alumina, or combinations thereof and the adsorbent material of the second vessel includes activated carbon, silica, alumina, or combinations thereof. The adsorbent material of these vessels can also include other adsorbent material or can alternatively include other suitable adsorbent material.

In a twelfth aspect, the adsorbent material of the first vessel can be configured to adsorb nitrogen, oxygen, carbon dioxide, water, carbon monoxide, or combinations thereof and the adsorbent material of the second vessel can be configured to adsorb nitrogen, oxygen, carbon dioxide, water, carbon monoxide, or combinations thereof.

In a thirteenth aspect, the adsorption system of the sixth aspect can include one or more features of the seventh aspect, eighth aspect, ninth aspect, tenth aspect, eleventh aspect, and/or twelfth aspect. For example, embodiments of the adsorption system can be configured to implement an embodiment of a method for operation of an adsorption system. Embodiments can also include other features or elements. Examples of such features or elements can be appreciated from the exemplary embodiments of the adsorption system discussed herein.

In a fourteenth aspect, a dynamic compressor apparatus for an adsorption system is provided. The dynamic compressor can be fluidly connectable to a first vessel when the first vessel is in a regeneration operational state and the dynamic compressor can also be fluidly connectable to a second vessel when the second vessel is in the regeneration operational state. The dynamic compressor can be positioned and configured to decrease a pressure of the first vessel to a pre-selected regeneration pressure to remove impurities from adsorbent material of the first vessel for a pre-selected regeneration period of time when the first vessel is in the regeneration operational state and the dynamic compressor can be configured to operate in a choke area of operation for a portion of the pre-selected regeneration period of time. The dynamic compressor can also be positioned and configured to decrease a pressure of the second vessel to the pre-selected regeneration pressure to remove impurities from the adsorbent material of the second vessel for the pre-selected regeneration period of time when the second vessel is in the regeneration operational state. The dynamic compressor can be configured to operate in a choke area of operation for a portion of the pre-selected regeneration period of time.

In a fifteenth aspect, the dynamic compressor can include at least one rotatable impeller and a motor positioned and configured to drive rotation of the at least one impeller at a constant speed of rotation. As noted above, in some types of constant speed motor arrangements, an induction motor for the dynamic compressor can be provided in which the rotational speed of the impeller(s) driven by the motor may change slightly due to a load applied to the motor (e.g. the rotational speed may vary from a particular setting by up to 2% depending on the load applied to the motor). This type of slight variation in speed can be typical for some types of constant speed arrangements that provide for a constant speed of rotation of the impeller(s) as the speed of the dynamic compressor that is connected directly or through a gearbox to a drive device that operates at a set speed (e.g. a constant speed).

In some embodiments, the dynamic compressor can include a single impeller or multiple impellers. In some embodiments, the dynamic compressor can include one or more intercoolers and/or an aftercooler.

In a sixteenth aspect, the portion of the pre-selected regeneration period of time at which the dynamic compressor is operatable in the choke area of operation is greater than 0% of the pre-selected regeneration period of time and is less than or equal to 60% of the pre-selected regeneration period of time. For instance, the dynamic compressor can be operatable in the choke area of operation for 5%-60% of the pre-selected regeneration period of time, 10%-60% of the pre-selected regeneration period of time, 10%-50% of the pre-selected regeneration period of time, 10%-40% of the pre-selected regeneration period of time, 20%-60% of the pre-selected regeneration period of time, 20%-50% of the pre-selected regeneration period of time, 15%-60% of the pre-selected regeneration period of time, or another portion of the pre-selected regeneration period of time.

It should be appreciated that embodiments of the process and system can utilize various conduit arrangements and process control elements. The embodiments may utilize sensors (e.g., pressure sensors, temperature sensors, flow rate sensors, concentration sensors, etc.), controllers, valves, piping, and other process control elements. Some embodiments can utilize an automated process control system and/or a distributed control system (DCS), for example. Various different conduit arrangements and process control systems can be utilized to meet a particular set of design criteria.

Other details, objects, and advantages of an adsorption system, an adsorption system compressor apparatus, method for operation of an adsorption system, and methods of making and using the same will become apparent as the following description of certain exemplary embodiments thereof proceeds.

### BRIEF DESCRIPTION OF THE DRAWINGS

Exemplary embodiments of an adsorption system, an adsorption system compressor apparatus, method for operation of an adsorption system, and methods of making and using the same are shown in the drawings included herewith. It should be understood that like reference characters used in the drawings may identify like components.

FIG. 1 (which can also be referred to as FIG. 1) is a block diagram of an exemplary embodiment of an adsorption system 1 that includes an embodiment of the adsorption system compressor apparatus.

FIG. 2 (which can also be referred to as FIG. 2) is a schematic illustration of an exemplary embodiment of a vessel 2a that can be utilized in embodiments of the adsorption system 1.

FIG. 3 (which can also be referred to as FIG. 3) is a graph illustrating an exemplary compressor operational profile by comparing percent head with percent inlet flow. The graph of FIG. 3 includes a surge limit line, a peak efficiency line, and an overload line. The percent head term for the y-axis of the graph in FIG. 3 refers to the dynamic compressor characteristic that is determined by a formula that includes the pressure ratio of the pressure at an outlet of the dynamic compressor divided by the inlet pressure of the dynamic compressor and various fluid thermodynamic properties including molecular weight, and ratio of specific heats. The graph is shown as a percentage of head, but can be considered as the percentage of pressure ratio in this process as the fluid composition only changes slightly through the cycle (e.g. [pressure at the compressor outlet]/[pressure at the compressor inlet]*100%). The percent inlet flow of the x-axis of the graph in FIG. 3 refers to the ratio of the volumetric flow rate at the outlet of the compressor as compared to the volumetric flow rate at the inlet of the compressor (e.g. [volumetric flow rate at the outlet of the compressor]/[volumetric flow rate at the inlet of the compressor]*100%). The choke area in FIG. 3 is the region of compressor performance where the impeller(s) of the dynamic compressor and other stationary parts of the compressor can become limited on volume flow due to “choking” of the individual parts where no additional flow is possible. In the choke area, which is a region that is to the right of the overload line, the efficiency of the compressor can be at a lower level and the impeller(s) and other parts may experience higher stress and/or strain forces from use. Another phenomenon for the choke area is that there will be more flow disturbances in the rotating impeller(s) of the compressor which is a result of the maximum flow rate or choking. For example, a compressor operating in the choke are, or choke region, would experience flow disturbances, which are accompanied with some pressure disturbances. These disturbances can cause higher stresses in the impeller(s) depending on the location and the pressure pulsation level. The surge area of the graph in FIG. 3 illustrates a region of operation of the compressor in which a flow rate lower than the surge limit line may cause a backflow of fluid from the outlet region, or discharge section, of the compressor (e.g. a backflow of fluid that passes backwards from a discharge region to the suction, or inlet region of the compressor).

FIG. 4 (which can also be referred to as FIG. 4) illustrates an exemplary embodiment of a method for operation of an adsorption system. An embodiment of the adsorption system 1 can be utilized to implement an embodiment of this method.

### DETAILED DESCRIPTION OF THE INVENTION

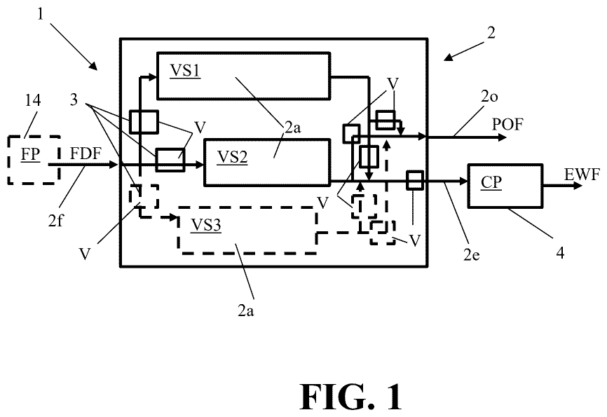

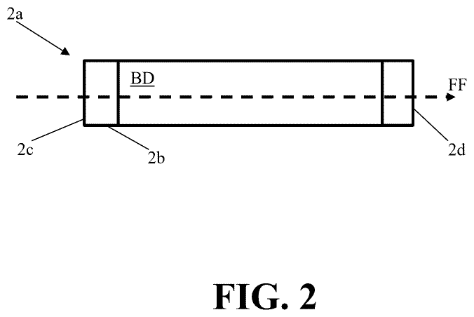

Referring to FIGS. 1-4, an adsorption system 1 can be positioned and configured so that an adsorption unit 2 can receive a feed flow of fluid (FDF) via a feed conduit 2f. The adsorption unit 2 can include a plurality of adsorber vessels 2a. Each adsorber vessel can include an adsorber vessel feed conduit that is in fluid communication with the feed conduit 2f for feeding the feed flow of fluid to the vessel 2a. Each adsorber vessel feed conduit can also include a valve (V). Each valve 3 of the vessel feed conduit can be adjustable between an open position and a closed position to control how the feed flow of fluid may be fed to the different vessels 2a.

Each vessel 2a can have a bed (BD) of adsorbent material positioned within a body 2b of the vessel. Each bed of adsorbent material can include one or more layers of adsorbent material for removal of one or more constituents of the feed flow of the fluid to output a more purified fluid as a purified output fluid (POF) via an output conduit 2o of the adsorption unit 2 that can be in fluid communication with an outlet of each vessel 2a. The adsorbent material can be solid particulates of adsorbent material, for instance. Examples of the adsorbent material can include activated carbon, alumina, silica, zeolites, CaX, other types of adsorbent materials, and combinations of such material. The one or more layers of adsorbent material can be positioned in the body 2b so that as a flow of fluid FF is passed from an inlet region 2c to an outlet region 2d of the body, the fluid contacts the adsorbent material and the adsorbent material removes one or more target impurities from the fluid (e.g. carbon dioxide, nitrogen, carbon monoxide, water, etc.).

The purified output fluid (POF) can have a lower concentration of one or more constituents of the feed flow of fluid (FDF). For example, the purified output fluid can have a lower concentration of carbon dioxide, water, nitrogen, carbon monoxide, and/or other constituent as compared to the feed flow of fluid. In some embodiments, the purified output fluid can be comprised mostly of oxygen gas, mostly carbon dioxide gas, mostly nitrogen gas, a combination of oxygen gas and nitrogen gas, hydrogen gas, carbon dioxide gas, or other gas or combination of gases. For instance, in some embodiments the purified fluid that is output can be mostly or almost entirely carbon dioxide gas. In such an embodiment, the adsorbent material can be provided to remove water, nitrogen, and/or other constituents for purification of the fluid to output a more purified carbon dioxide gas, for example.

The adsorption unit 2 can include a plurality of vessels 2a or sets of vessels. The vessels 2a can include a first vessel VS1 and a second vessel VS2, for example, Each vessel 2a can be a single vessel or a group of vessels that may operate in parallel, for example. Some embodiments can include additional vessels 2a. For example there can include a third vessel VS3. Other embodiments can utilize at least four vessels, at least six vessels, at least eight vessels, at least twelve vessels, or another arrangement of vessels.

The vessels 2a can be pressurized to a pre-selected purification pressure for adsorption processing of the feed flow of fluid (FDF) fed to the vessels for purification while each of the vessel(s) 2a is in a purification operational state. This pre-selected purification pressure can be a pre-selected maximum pressure or other suitable pressure for a cycle of operation of the vessel(s) 2a. After the adsorbent material has been utilized for purification for a pre-selected time period or a pre-selected flow of the fluid (e.g. a period of time between 2 hours and 6 hours, a period of time between 1 hour and 4 hours, etc.), the vessel(s) 2a can begin to undergo depressurization to a pre-selected minimum pressure for regeneration of the adsorbent material. While this depressurization occurs for that vessel or set of vessels, another vessel 2a or set of vessels of the adsorption unit 2 can be fluidly connected to the feed flow of fluid (FDF) for purification of the fluid at the pre-selected purification pressure for a pre-selected time period. This type of cycling of vessels between purification, depressurization and regeneration can occur repeatedly for a large number of cycles of operation.

For example, the adsorption unit 2 can be configured so that at least one of the vessels 2a of the adsorption unit 2 receives the feed flow of fluid (FDF) for removal of one or more impurities from the fluid to produce the purified output fluid (POF) while one or more of the other vessels may undergo regeneration of the adsorbent material within the body 2b of the vessel(s) 2a. In such processing, the one or more vessels 2a that receive the feed flow of fluid for purification of that fluid can output the purified fluid for being fed to the output conduit 2o. This can be provided via closing and/or opening of valves in a conduit arrangement positioned between an outlet end 2d of the vessel(s) and the output conduit 2o of the adsorption unit 2, for example.

The one or more vessels 2a that can undergo regeneration of their adsorbent material while other vessels are purifying the feed flow of fluid (FOF) can be depressurized for triggering the adsorbent material to release captured impurities for evacuation of those impurities. For example, the depressurized vessels 2a and can undergo a reduction of pressure from the pre-selected purification pressure to a pre-selected regeneration pressure when operating in a regeneration state of operation. A valve 3 of the vessel feed conduit can then be closed and a conduit arrangement between an outlet end 2d of the vessel 2a and the output conduit 2o of the adsorption unit 2 can be adjusted so that a dynamic compressor 4 is in fluid communication with the vessel 2a so that an inlet end, or suction end, of the dynamic compressor (CP) is in fluid communication with the vessel 2 via a compressor inlet conduit 2e positioned between the vessels 2a and the dynamic compressor 4. This type of conduit arrangement adjustment for the conduit arrangement between an outlet end 2d of the vessel 2a and the output conduit 2o can be provided via adjustments of different values V of the conduit arrangement between opened and closed positions, for example.

The dynamic compressor (CP) can include at least one impeller that is driven by a motor to rotate the impeller(s) to create a pressure differential for evacuating fluid from within the vessel(s) 2a undergoing regeneration to remove the impurities desorbed from the adsorbent material from the vessel 2a. In some embodiments, the dynamic compressor may include multiple impellers and/or may include intermediate cooling between impellers. For example, the compressor 4 can have one or more impellers that are rotated to increase the pressure of fluid received via the inlet conduit 2e for outputting the fluid from an outlet of the compressor 4. The fluid output from the compressor 4 can be an evacuated waste fluid (EWF) that is fluid from within the vessel 2a undergoing regeneration. This evacuated waste fluid (EWF) can include impurities that desorbed from the adsorbent material within the vessel due to the change in pressurization of the vessel(s) 2a undergoing regeneration. This evacuation of the impurities can occur via the fluid connection between the inlet conduit 2e of the dynamic compressor 4 and the vessel(s) 2a undergoing regeneration.

The dynamic compressor (CP) can be configured with a drive motor system coupled to the dynamic compressor so that the impeller(s) can be configured to rotate at a pre-selected rotational speed for driving the flow of the evacuated waste fluid (EWF) from out of the vessel(s) 2a undergoing regeneration. The drive motor system can include a gearbox, a moveable shaft, seals, and other components, for example.

The evacuate waste fluid (EWF) output from the compressor (CP) can be vented. Prior to venting, the fluid may be utilized as a heat exchanger fluid for cooling or heating in some embodiments.

In some embodiments, the dynamic compressor (CP) can be configured to operate at a constant rotational speed. The rotational speed of the impeller(s) may not change after it is started up and reaches its pre-selected rotational speed as the compressor is utilized to drive the evacuated waste fluid (EWF) out of the body 2b of the vessel 2a for each vessel undergoing regeneration.

The adsorption system 1 can include an adsorption system compressor apparatus that includes the dynamic compressor 4. The adsorption system compressor apparatus can also include a conduit arrangement for fluid connection of the compressor 4 to the vessels 2a to facilitate evacuation of the vessels during a regeneration state of operation utilized for regeneration of adsorbent material of the vessels. In some embodiments, the dynamic compressor 4 can be a centrifugal compressor that has a single impeller or multiple impellers.

The fluid connection of the dynamic compressor 4 to the vessel 2a for undergoing evacuation of the impurities and closing of the valve 3 of the feed conduit of the vessel 2a can result in the pressure of the vessel 2a being at a pre-selected minimum pressure. Such a pressure can be a pressure that is less than 102 kPa. For example, the pre-selected regeneration pressure of the vessel while the vessel undergoes evacuation can be below atmospheric pressure (e.g. can be below 102 kPa and greater than or equal to 10 kPa, etc.) or can be another suitable pre-selected regeneration pressure for evacuation of the vessel having the bed (BD) of adsorbent material for removal of impurities that desorbed from the material via the change in pressure of the vessel between its higher pre-selected purification pressure to its lower pre-selected regeneration pressure. The pre-selected regeneration pressure can be a pre-selected minimum pressure that the vessel undergoes during its cycle of operation between purification processing of the feed of fluid (FDF) and regeneration of the adsorbent material.

Each vessel 2a of the adsorption unit 2 can be cycled between a purification state in which it receives the feed of fluid (FDF) for purification of the fluid and outputting of the purified output fluid (POF) and a regeneration state in which the vessel 2a undergoes evacuation via being fluidly connected to the dynamic compressor 4 repeatedly during operations. Each vessel 2a can also undergo a depressurization as the vessel's pressure is decreased from its pre-selected purification pressure to its pre-selected regeneration pressure and can also undergo a pressurization as the vessel is adjusted from its regeneration state to a purification state. The pressurization of the vessel 2a can be provided via the feeding of the feed of fluid to the vessel for purification of the fluid. The depressurization of the vessel 2a can occur via adjustment of valves of the feed and/or output conduit arrangements for the vessel that can result in the vessel pressure decreasing as it is transitioned from a purification state to a regeneration state.

I have surprisingly found that the dynamic compressor (CP) can be operated for facilitating regeneration of the vessels 2a as they cycle between their purification state of operation and regeneration state of operation so that the impeller(s) of the dynamic compressor 4 can operate at a pre-selected constant speed of rotation. The dynamic compressor 4 can also operate so that during an initial phase of evacuation of fluid from the vessel undergoing regeneration, the compressor operates in a choke region, or choke area, of operation. As evacuation of fluid from the vessel progresses, the compressor's operation can result in the majority of the operation of the compressor during the regeneration phase operating in a region that is above its choke area or operation and also below its surge area of operation. The limited operation of the compressor 4 to cyclically undergo a choke area of operation has been surprisingly found to allow the compressor 4 to operate more efficiently than a conventional blower without negatively affecting the life of the compressor and/or impeller(s) of the compressor via the higher stress that can occur via its operation in the choke area of operation.

In some embodiments, the outlet region of the dynamic compressor 4 (e.g. an outlet of the compressor, a discharge end of the compressor, or a portion of an outlet conduit to which a discharge outlet of the compressor is connected, etc.) can have at least one flow restrictor (e.g. a restriction orifice, etc.). Such a flow restrictor can be utilized to help reduce the time period in which the dynamic compressor may operate in the choke area of operation.

I have surprisingly found that this type of operational profile in which the dynamic compressor 4 may operate in the choke area of operation can permit the dynamic compressor to be utilized so that the compressor can have a simplified motor and impeller configuration that only has the impeller(s) configured for a constant rotational speed, which is a much simpler motor configuration than a variable speed motor. Use of such a configuration can also facilitate a simplified process control scheme because of the simplified compressor operation. Further, utilization of the dynamic compressor 4 can permit a more efficient utilization of electrical power as compared to conventional blowers. Embodiments of a dynamic compressor can operate at 80-85% efficiency, which is much higher than a conventional blower's power efficiency (typically being 60%-65%). These features can permit embodiments of the adsorption system to have a significantly lower capital cost, lower operational cost via the reduced power consumption, and lesser environmental impact due to the more efficient use of electrical power. Embodiments that may utilize a constant speed motor can also permit a more simplified process control scheme that can facilitate a more flexible operation of the adsorption system and plant that may incorporate or utilize the adsorption system 1 (e.g. there can be less control variables associated with operation of the compressor that has to be managed in controlling operations of the adsorption system 1 and other plant units, etc.).

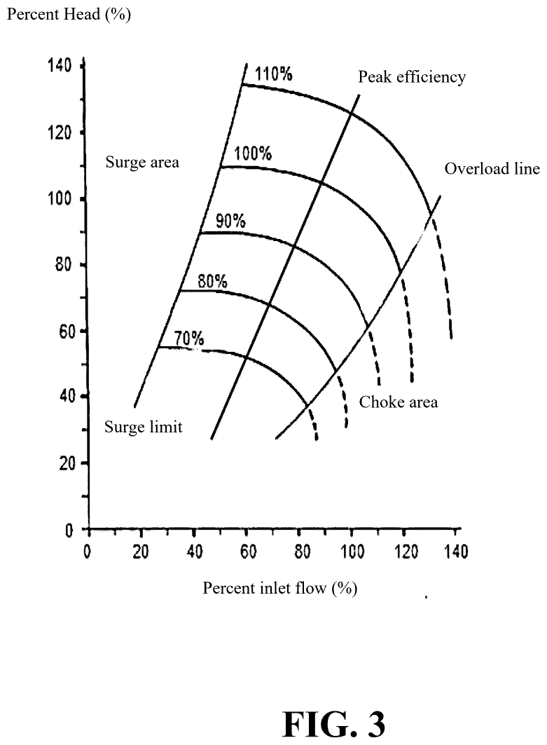

FIG. 3 illustrates a graph for an exemplary operation profile of an exemplary embodiment of a compressor 4 to help further illustrate the choke area operation of the dynamic compressor 4 that can be utilized in embodiment of the adsorption system 1. Different compressors 4 can have different types of operational profiles. Each compressor can have a choke area of operation as well as a surge area of operation associated with its configuration and use.

As may be seen in the graph of FIG. 3, the compressor 4 can have a surge area as indicated by the surge limit line, a choke area of operation that is indicated by the overload line, and a peak efficiency line that can be located between the overload line and the surge limit line. Typically, the peak efficiency line is a region of operation for the compressor 4 that can be a desired operational state for the compressor 4 to maximize cost-effective utilization of the compressor.

The percent head term for the y-axis of the graph in FIG. 3 refers to the dynamic compressor characteristic that is determined by a formula that includes the pressure ratio of the pressure at an outlet of the dynamic compressor divided by the inlet pressure of the dynamic compressor and various fluid thermodynamic properties including molecular weight, and ratio of specific heats. The graph is shown as a percentage of head, but can be considered as the percentage of pressure ratio in this process as the fluid composition only changes slightly through the cycle (e.g. [pressure at the compressor outlet]/[pressure at the compressor inlet]*100%). The percent inlet flow of the x-axis of the graph in FIG. 3 refers to the ratio of the volumetric flow rate at the outlet of the compressor as compared to the volumetric flow rate at the inlet of the compressor (e.g. [volumetric flow rate at the outlet of the compressor]/[volumetric flow rate at the inlet of the compressor]*100%).

The choke area in FIG. 3 is the region of compressor performance where the impeller(s) of the dynamic compressor and other stationary parts of the compressor can become limited on volume flow due to “choking” of the individual parts where no more flow is possible. In the choke area, which is a region that is to the right of the overload line in FIG. 3, the efficiency of the compressor can be at a lower level and the impeller(s) and other parts may experience higher stress and/or strain forces from use. Another phenomenon for the choke area is that there will be more flow disturbances in the rotating impeller(s) of the compressor when the compressor operates in the choke area. For example, a compressor operating in the choke are, or choke region, would experience flow disturbances, which are accompanied with some pressure disturbances. These disturbances can cause higher stresses in the impeller(s) depending on the location and the pressure pulsation level. A choke area, or choke region of operation can also be referred to as a stonewall or can be referred to as a stonewall area of operation.

The surge area of the graph in FIG. 3 illustrates a region of operation of the compressor 4 in which a flow rate lower than the surge limit line may cause a backflow of fluid from the outlet region, or discharge section, of the compressor (e.g. a backflow of fluid that passes backwards from a discharge region to the suction, or inlet region of the compressor).

Conventionally, a compressor is operated to avoid operation in a choke area because it provides low efficiency and also can add significant and undesired stress onto the impeller(s) and other components of the compressor. Often a supplier of a compressor will limit a customer from operating the compressor in a choke area of operation due to concerns that the supplier has with such high stresses and damage that may be caused by those higher stresses.

However, it was surprisingly determined that compressors can be utilized in PSA, VSA, and VPSA type systems when operating in their choke area of operation. These types of adsorption systems can have a relatively low suction pressure to the compressor as compared to most other processes. The outlet of the compressor in these processes are also relatively low. A compressor will develop a pressure rise in a compressor to the outlet section and this pressure rise is dependent on many things, including the adsorption system process design, the pressure level on the inlet and outlet ends of the compressor, the fluid compressed and the size of the compressor.

For the PSA, VSA, and VPSA processing, it was determined that the outlet pressure is relatively low as compared to other processes (e.g. 100 kPa to 200 kPa, often no more than 500 kPa., etc.). The lower pressures particularly true for VSA and VPSA processes due to the lower vacuum suction pressure and output pressures (e.g. a discharge pressure in a range of 5 kPa to 15 kPa, etc.). A dynamic compressor 4 operating to facilitate evacuation for regeneration of adsorbent material can operate in the choke are for an initial period of time during the regeneration of the adsorbent material. For instance, when the bed BD of adsorbent material in the body 2b of the vessel(s) 2a undergoing regeneration starts to be evacuated after a switch from one set of absorption vessels to another occurs, the compressor may initially operate in the choke area of operation because of the pressure fluctuations in the impeller(s) that can occur due to the flow fluctuations. However, this choke area of operation may only occur for a relatively limited extent of the vessel evacuation processing. For instance, operation in the choke area of the compressor may only occur for a time that is greater than 0% to 60%, greater than 0% to 15%, 5%-15%, 5%-50%, 5%-60%, 5%-50%, 10%-50%, 10%-40%, 5%-25%, or 5%-30% of the pre-selected evacuation period of time in which the compressor 4 operates for evacuating the vessel(s) for removal of impurities and regeneration of the adsorbent material. The extent to which operation in the choke area of operation can depend on the absorption process as well as the specific characteristics of the selected dynamic compressor CP that may be utilized for a particular embodiment and the particular pre-defined choke area of operation for the compressor, which can often be defined by the supplier of the dynamic compressor that may be utilized in a particular embodiment.

It was determined that this limited operation in the choke area can be acceptable and avoid incurring substantive high stresses on the impeller(s) of the compressor that may be problematic for the life of the compressor(s). This was surprisingly found to be the case due to a combination of the amount of time in the choke region of operation that may occur and the lower stresses in the compressor that apply when the compressor operates in its choke region of operation at these lower operating pressures. This is a surprising result because it is contrary to conventional thinking and guidance for compressor operation that is typically provided by compressor suppliers.

The surprising efficiency improvement in operation that can be provided via use of a dynamic compressor CP can be further enhanced in embodiments that can be implemented by using a dynamic compressor 4 having a pre-selected constant speed motor to drive rotation for the impeller(s) of the compressor as noted above. This type of feature can permit the compressor's overall capital cost to be reduced and can allow for a more straightforward, simplified process control scheme to provide greater flexibility in design and operation of a plant that may incorporate the adsorption system 1 having a compressor apparatus that includes the dynamic compressor CP.

The adsorption system can be a PSA system, VSA system, or VPSA system, for example. In some embodiments (as may be appreciated from the above), an adsorption system 1 can include a first vessel VS1 adjustable between a purification operational state and a regeneration operational state wherein the first vessel VS1 has a bed BD of adsorbent material within a body 2b of the first vessel. A second vessel VS2 can also be included in the system. The second vessel VS2 can be adjustable between the purification operational state and the regeneration operational state so that the second vessel VS2 is in the purification operational state when the first vessel VS1 is in the regeneration operational state and the second vessel VS2 is in the regeneration operational state when the first vessel VS1 is in the purification operational state.

A dynamic compressor (CP) can be positioned to be fluidly connectable to the first vessel VS1 when the first vessel VS1 is in the regeneration operational state and the dynamic compressor 4 can be positioned to be fluidly connectable to the second vessel VS2 when the second vessel VS2 is in the regeneration operational state. The first vessel can be fluidly connectable to an adsorption unit feed conduit 2f for receiving a process gas for purification of the process gas when the first vessel VS1 is in the purification operational state. The second vessel VS2 can also be connectable to the adsorption unit feed conduit for receiving the process gas for purification of the process gas when the second vessel VS2 is in the purification operational state.

The dynamic compressor 4 can be positioned and configured to decrease a pressure of the first vessel VS1 to a pre-selected regeneration pressure to remove impurities from the adsorbent material of the first vessel VS1 for a pre-selected regeneration period of time when the first vessel VS1 is in the regeneration operational state. The dynamic compressor configured to operate in a choke area of operation for a portion of the pre-selected regeneration period of time. Also, the dynamic compressor 4 can be positioned and configured to decrease a pressure of the second vessel VS2 to the pre-selected regeneration pressure to remove impurities from the adsorbent material of the second vessel VS2 for the pre-selected regeneration period of time when the second vessel VS2 is in the regeneration operational state. The dynamic compressor can be configured to operate in the choke area of operation for a portion of the pre-selected regeneration period of time as well.

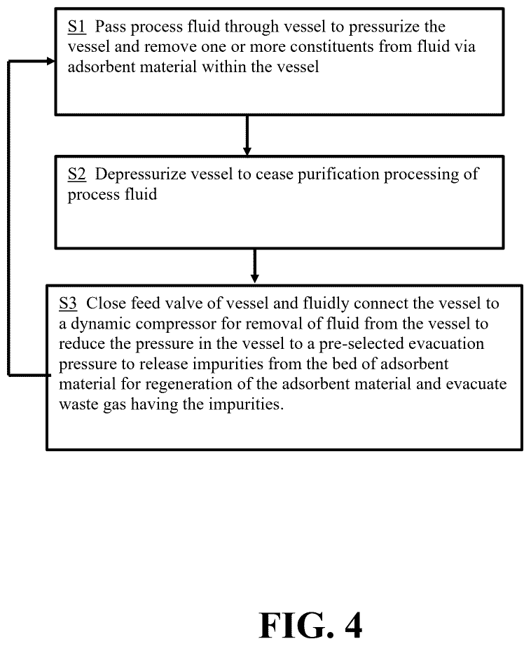

Embodiments of the system can be utilized to implement an embodiment of a method for operation of an adsorption system. For example, as shown in FIG. 4, an exemplary embodiment of the method can include a first step S1 that includes passing process fluid through at least one vessel 2a of the adsorption unit 2 of the adsorption system 1 to pressurize the vessel and remove one or more constituents from the fluid via adsorbent material within the vessel(s) 2a. For example, adsorbent material within the bed (BD) of the body 2b for each vessel 2a that has fluid passed through the vessel 2a can contact the fluid passed through the vessel 2a to adsorb one or more impurities from the fluid for outputting a purified output fluid (POF). The passing of fluid for purification of that fluid can occur for a pre-selected purification time period at a pre-selected purification pressure.

In a second step S2, each of the vessel(s) 2a can be transitioned from a purification state to a regeneration state via depressurization of the vessel(s) 2a to cease purification processing of the process of fluid. This transition can occur at the same time other vessels that ae in a regeneration state undergo pressurization to be placed into a purification state for purifying a process fluid while the other vessels are transitioned from the purification state to the regeneration state. An adjustment of valves V of the conduits of the adsorption unit 2 can be provided to adjust the pressurization of the vessels 2a and transition the vessels between their purification state of operation and regeneration state of operation.

In a third step S3, a feed valve for each vessel that is transitioned to its regeneration state of operation can be performed and each vessel 2a in the regeneration operational state can be fluidly connected to a dynamic compressor 4 for removal of fluid from the vessel to reduce the pressure in the vessel to a pre-selected evacuation pressure to release impurities from the bed of the adsorbent material in the vessel for regeneration of the adsorbent material and to evacuate waste gas having the impurities from the vessel(s) 2a. The evacuation of the waste gas can occur at a pre-selected regeneration pressure via the dynamic compressor's operation and can occur for a pre-selected evacuation time period or a pre-selected regeneration time period. The evacuated waste gas can be output from the dynamic compressor for being vented. Prior to venting, the waste gas may be utilized as a heat transfer fluid for a plant process in some embodiments.

In this third step S3, the initial evacuation of the impurities via the dynamic compressor can be performed such that the dynamic compressor operates in its choke area of operation. This can occur for a portion of the overall pre-selected evacuation time period or a pre-selected regeneration time period. For instance, the dynamic compressor can operate in the choke aera of operation for greater than 0% to 60% of the overall pre-selected evacuation time period or a pre-selected regeneration time period. For example, in some embodiments, the dynamic compressor can operate in the choke aera of operation for 5% to 50% of the overall pre-selected evacuation time period or a pre-selected regeneration time period. As another example, the dynamic compressor can operate in the choke aera of operation for 15% to 40% of the overall pre-selected evacuation time period or a pre-selected regeneration time period in other embodiments. Yet other embodiments can utilize other choke area of operation time periods so that the dynamic compressor can operate in the choke aera of operation for a pre-selected portion of the overall pre-selected evacuation time period (e.g. the dynamic compressor can operate in its choke aera of operation for 5%-60%, 10%-40%, 5%-30%, 10%-45%, 15%-50%, or other suitable portion of the overall pre-selected evacuation time period).

Thereafter, the vessel(s) 2a in the regeneration state can be transitioned back to a purification state via repressurization of the vessel(s) 2a. This can occur so that the vessels in the regeneration state can be transitioned back to their purification state while other vessels that were in a purification operational state can be transitioned to the regeneration state. Such a transition is indicated in FIG. 4 via the illustration of the method returning to the first step S1 for initiation of a new cycle of operation.

The cycling of pressure between the higher purification pressure to the lower regeneration pressure can occur numerous times in continuous fashion as the adsorption system operates. for example, the purification time period may be between 1-6 hours or 2-6 hours and the regeneration time period can also range from 1-6 hours or 2-6 hours. Such cyclical pressure can occur frequently during operations of a plant having the adsorption system 1.

During the evacuation of impurities that can occur in the third step S3, the dynamic compressor can operate at a constant rotational speed via a drive motor coupled to at least one impeller of the compressor that is configured for driving the rotational speed of the impeller(s) at a pre-selected constant rotational speed. For some types of constant speed motor arrangements, an induction motor for the dynamic compressor may change slightly due to a load applied to the motor (e.g. the rotational speed may vary from a particular setting by up to 2% depending on the load applied to the motor). This type of slight variation in speed can be typical for such a constant speed arrangement that provides for a constant speed of rotation as the speed of the dynamic compressor that is connected directly or through a gearbox to a drive device that operates at a set speed (e.g. a constant speed). This type of constant speed arrangement is substantially different form a variable frequency drive (VFD) control unit, which can result in speed adjustments of as much as a 50% change in rotational speed based on different loads applied to the motor of the VFD. Also, a constant speed configuration is much less expensive than a VFD configuration.

For a connected motor, the speed will be based on the connected motor characteristics and the electrical grid frequency. A connected motor could also be designed with the addition of a variable speed device that is set at a single speed. The dynamic compressor could also be constant speed when connected to a steam turbine driver or gas turbine driver that is set to a single constant speed. The efficiency with which electrical power may be utilized by the compressor can be greater than 80% in embodiments of the method. As noted above, this can provide a significant improvement in efficient use of electrical power as compared to conventional blowers and can also help reduce the carbon footprint associated with operation of the adsorption system via this more efficient utilization of power. This type of improvement can also help reduce the operational costs associated with operation of the adsorption system.

It has also been determined that some embodiments can be provided in which a feed compressor (FP) that can compress a feed of process fluid to output the feed flow of fluid (FOF) can be positioned and configured to operate in a choke region of operation for a portion of time during operation in some situations for feeding a feed flow of fluid to an adsorption unit 2 of the adsorption system 1. An example of such an embodiment can be appreciated from the broken line illustration of a feed compressor 14 in FIG. 1, for instance.

For example, in situations where a feed may be fed to an adsorption system for purification of the feed flow of fluid (FOF) in which the pressurization may be relatively minimal (e.g. about ambient pressure in a range of 125 kPa to 101 kPa for undergoing adsorption), the feed compressor 14 (FP) may be operated in a choke region of operation in some situations (e.g. during a start-up portion of operations, at different pre-selected phases during a cycle of operation, etc.) to facilitate pressurization of the feed flow of fluid for feeding to at last one vessel 2a of the adsorption system. This may be utilized in situations in which there is desire to purify a feed flow of fluid to obtain a higher concentration of oxygen within the purified flow of fluid output from the adsorption unit 2 in some embodiments, for example. In such embodiments, it is contemplated that the feed compressor 14 can be a dynamic compressor that is configured to operate at a constant speed.

In some embodiments, the feed compressor 14 can be used in conjunction with the dynamic compressor 4 as well. Such a configuration can be seen from FIG. 1, as noted above (e.g. via broken line illustration of the feed compressor 14). In some embodiments, the feed compressor 14 and the dynamic compressor 4 can be integrated into a single machine configuration in which these compressors operate via a common drive system and common shaft of rotation. In other embodiments, the feed compressor 14 and dynamic compressor 4 can be separate units that have separate drive units that rotate separate one or more rotational shafts for driving rotation of the impeller(s) of the different dynamic compressors.

While this feed compressor 14 utilization is possible, other embodiments may only utilize a dynamic compressor 4 without use of the feed compressor 14. Also, some embodiments can be configured so that only operation of the feed compressor 14 may occur (e.g. without use of a downstream dynamic compressor 4). For instance, it is contemplated that utilization of a feed compressor 14 for feeding a flow of feed fluid to an adsorption unit in which the feed compressor 14 is able to operate in a choke region of operation for some, if not all, of a time period of operation, can provide operational improvements as well as reduced capital costs. Such a feed compressor 14 can be configured to utilize a constant speed drive system as noted above as well. In such situations, the added benefit of utilizing the dynamic compressor 4 as discussed above may not be necessary or desired due to other design criteria or design objectives.

It should also be appreciated that modifications to embodiments of the apparatus 1 and method can also be made to meet a particular set of criteria for different embodiments of the apparatus or method. For instance, the arrangement of valves, sensors, piping, and other conduit elements (e.g., conduit connection mechanisms, tubing, seals, valves, etc.) for interconnecting different units of the apparatus for fluid communication of the flows of fluid between different elements can be arranged to meet a particular facility layout design that accounts for available area of the apparatus, sized equipment of the apparatus, a preferred type of automated process control scheme and/or distributed control scheme, and other design considerations. The size or type of the equipment can be modified to meet a particular set of design criteria as well.

As yet another example, it is contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of the method, apparatus, system, and methods of making and using the same have been shown and described above, it is to be distinctly understood that the invention is not limited thereto but may be otherwise variously embodied and practiced within the scope of the following claims.

What is claimed is:

1. A method for operation of an adsorption system, the method comprising:
passing a process fluid through a vessel to pressurize the vessel and adsorb one or more impurities from the process fluid via a bed of adsorbent material within a body of the vessel while the vessel is at a pre-selected purification pressure;
fluidly connecting the vessel to a dynamic compressor to adjust a pressure of the vessel to a pre-selected regeneration pressure that is lower than the pre-selected purification pressure to evacuate fluid from the vessel for removal of impurities desorbed from the adsorbent material.

2. The method of claim 1, further comprising:
operating the dynamic compressor in a choke area of operation while fluid from the vessel is evacuated for removal of the impurities.

3. The method of claim 2, wherein the fluid is evacuated from the vessel for removal of the impurities for a pre-selected regeneration period of time and the dynamic compressor is operated in the choke area of operation for a period of time that is greater than 0% of the pre-selected regeneration period of time and is less than or equal to 60% of the pre-selected regeneration period of time.

4. The method of claim 3, wherein the pre-selected regeneration period of time is between 1 hour and 6 hours.

5. The method of claim 1, wherein the dynamic compressor is a centrifugal compressor having at least one impeller.

6. The method of claim 5, wherein the dynamic compressor includes a motor positioned and configured to drive rotation of the at least one impeller at a constant speed of rotation.

7. The method of claim 5, wherein the adsorption system is a pressure swing adsorption system, a vacuum swing adsorption system, or a vacuum-pressure swing adsorption system.

8. The method of claim 1, wherein the one or more impurities include nitrogen, carbon dioxide, water, carbon monoxide, or combinations thereof.

9. The method of claim 1, wherein the adsorbent material includes activated carbon, silica, alumina, or combinations thereof.

10. An adsorption system, comprising:
a first vessel adjustable between a purification operational state and a regeneration operational state, the first vessel having a bed of adsorbent material within a body of the first vessel;
a second vessel adjustable between the purification operational state and the regeneration operational state so that the second vessel is in the purification operational state when the first vessel is in the regeneration operational state and the second vessel is in the regeneration operational state when the first vessel is in the purification operational state;
a dynamic compressor, the dynamic compressor being positioned to be fluidly connectable to the first vessel when the first vessel is in the regeneration operational state and the dynamic compressor positioned to be fluidly connectable to the second vessel when the second vessel is in the regeneration operational state;
the first vessel being fluidly connectable to an adsorption unit inlet conduit for receiving a process gas for purification of the process gas when the first vessel is in the purification operational state;
the second vessel being fluidly connectable to the adsorption unit inlet conduit for receiving the process gas for purification of the process gas when the second vessel is in the purification operational state;
the dynamic compressor positioned and configured to decrease a pressure of the first vessel to a pre-selected regeneration pressure to remove impurities from the adsorbent material of the first vessel for a pre-selected regeneration period of time when the first vessel is in the regeneration operational state, the dynamic compressor configured to operate in a choke area of operation for a portion of the pre-selected regeneration period of time; and
the dynamic compressor positioned and configured to decrease a pressure of the second vessel to the pre-selected regeneration pressure to remove impurities from the adsorbent material of the second vessel for the pre-selected regeneration period of time when the second vessel is in the regeneration operational state, the dynamic compressor configured to operate in the choke area of operation for the portion of the pre-selected regeneration period of time.

11. The adsorption system of claim 10, wherein the dynamic compressor is a centrifugal compressor.

12. The adsorption system of claim 10, wherein the portion of the pre-selected regeneration period of time at which the dynamic compressor is operatable in the choke area of operation is greater than 0% of the pre-selected regeneration period of time and is less than or equal to 60% of the pre-selected regeneration period of time.

13. The adsorption system of claim 12, wherein the pre-selected regeneration period of time is between 1 hour and 6 hours.

14. The system of claim 10, wherein the dynamic compressor includes at least one rotatable impeller and a motor positioned and configured to drive rotation of the at least one impeller at a constant speed of rotation.

15. The adsorption system of claim 10, wherein the adsorption system is a pressure swing adsorption system, a vacuum swing adsorption system, or a vacuum-pressure swing adsorption system.

16. The adsorption system of claim 10, wherein the adsorbent material of the first vessel includes activated carbon, silica, alumina, or combinations thereof and the adsorbent material of the second vessel includes activated carbon, silica, alumina, or combinations thereof.

17. The adsorption system of claim 10, wherein the adsorbent material of the first vessel is configured to adsorb nitrogen, oxygen, carbon dioxide, water, carbon monoxide, or combinations thereof and the wherein the adsorbent material of the second vessel is configured to adsorb nitrogen, oxygen, carbon dioxide, water, carbon monoxide, or combinations thereof.

18. A dynamic compressor apparatus for an adsorption system, comprising:
a dynamic compressor fluidly connectable to a first vessel when the first vessel is in a regeneration operational state and the dynamic compressor also fluidly connectable to a second vessel when the second vessel is in the regeneration operational state;
the dynamic compressor positioned and configured to decrease a pressure of the first vessel to a pre-selected regeneration pressure to remove impurities from adsorbent material of the first vessel for a pre-selected regeneration period of time when the first vessel is in the regeneration operational state, the dynamic compressor configured to operate in a choke area of operation for a portion of the pre-selected regeneration period of time; and
the dynamic compressor positioned and configured to decrease a pressure of the second vessel to the pre-selected regeneration pressure to remove impurities from the adsorbent material of the second vessel for the pre-selected regeneration period of time when the second vessel is in the regeneration operational state, the dynamic compressor configured to operate in the choke area of operation for the portion of the pre-selected regeneration period of time.

19. The dynamic compressor apparatus of claim 18, wherein the dynamic compressor includes at least one rotatable impeller and a motor positioned and configured to drive rotation of the at least one impeller at a constant speed of rotation.

20. The dynamic compressor apparatus of claim 18, wherein the portion of the pre-selected regeneration period of time at which the dynamic compressor is operatable in the choke area of operation is greater than 0% of the pre-selected regeneration period of time and is less than or equal to 60% of the pre-selected regeneration period of time.
